(19) United States
(12) Patent Application Publication
(10) Pub. No.: US 2020/0367573 A1
(43) Pub. Date: Nov. 26, 2020

(54) Vaping Phone

(71) Applicant: Wei Liu, Memphis, TN (US)

(72) Inventor: Wei Liu, Memphis, TN (US)

(21) Appl. No.: 16/422,347

(22) Filed: May 24, 2019

(51) Int. Cl. A24F 47/00; A24F 7/00

(52) U.S. Cl. CPC A24F 47/008; H04M 1/0202; A24F 7/00

(57) ABSTRACT

A vaping phone is a cell phone incorporated with a vape pen, dab pen, similar battery-powered smoking device with the phone's battery powering both the cell phone and the smoking device with an extendable or fixed mouthpiece on the phone.

### CROSS-REFERENCE TO RELATED APPLICATIONS

None

### STATEMENT REGARDING FEDERALLY SPONSORED RESEARCH OR DEVEOPMENT

This is solely my personal invention and is NOT made with or related to federal funding

### REFERENCE TO A “SEQUENCE L LISTING ”

None

### BACKGROUND OF THE INVENTION

I came upon this idea of vaping phone when I have realized that almost every adult has a cell phone with a large-capacity battery and vape pens need a battery to function as well. If a vape pen, dab pen or similar battery-powered smoking device is incorporated into a cell phone, the battery in cell phones can also power this smoking device, and thus there is no need for a separate battery for the smoking device. And such smokers only need to a vaping phone and do not have to carry a separate vape pen, dab pen, or similar battery-powered smoking device.

### BRIEF SUMMARY OF THE INVENTION

This invention is to incorporate a vape pen, dab pen, or similar battery-powered smoking device into a cell phone with the phone's battery powering both the cell phone and the smoking device.

### BRIEF DESCRIPTION OF DRAWINGS

No drawing is necessary and thus not provided herein.

### DETAILED DESCRIPTION OF THE INVENTION

This invention is to incorporate a vape pen, dab pen, or similar battery-powered smoking device into a cell phone and to let the cell phone's battery power both the cell phone and the smoking device, which means that there is no need for a separate battery to power the smoking device, and that such smokers only need a vaping phone and do not have to carry a separate vape pen, dab pen or similar battery-powered smoking device.

The mouthpiece of the vape pen, dab pen or similar battery-powered smoking device can be extendable or fixed on the cell phone.

1. This is to claim the invention of incorporating a vape pen, dab pen, or similar battery-powered smoking device into a cell phone and letting the cell phone's battery power both the cell phone and the smoking device with an extendable or fixed mouthpiece on the cell phone.
